(19) United States
(12) Patent Application Publication
(10) Pub. No.: US 2007/0239294 A1
(43) Pub. Date: Oct. 11, 2007

(54) Hearing instrument having audio feedback capability

(76) Inventors: Andrea Brueckner, Zurich (CH); Lukas Florian Erni, Zurich (CH); Franziska Barbara Pfisterer, Birmensdorf (CH)

Correspondence Address: PEARNE & GORDON LLP, 1801 EAST 9TH STREET, SUITE 1200, CLEVELAND, OH, 44114-3108, US

(21) Appl. No.: 11/392,196

(22) Filed: Mar. 29, 2006

(51) Int. Cl. G06F 17/00; H04R 5/00

(52) U.S. Cl. 700/94; 381/22

(57) ABSTRACT

The method for operating a hearing instrument (100) having audio feedback capability, comprises the steps of
retrieving coded audio data from a storage element (9) of the hearing instrument (100);
decoding (12) the coded audio data, thereby generating a decompressed audio message signal;
optionally processing the decompressed audio message signal by a processing unit (4); and outputting the decompressed and optionally processed audio message signal to a user.

### FIELD OF THE INVENTION

The invention relates to the field of hearing instruments. It relates to a method for operating a hearing instrument having audio feedback capability, a hearing instrument having audio feedback capability, and a method for manufacturing a hearing instrument having audio feedback capability.

### BACKGROUND OF THE INVENTION

The term “hearing instrument” or “hearing device”, as understood here, denotes on the one hand hearing aid devices that are therapeutic devices improving the hearing ability of individuals, primarily according to diagnostic results. Such hearing aid devices may be for instance Outside-The-Ear hearing aid devices or In-The-Ear hearing aid devices or cochlear implants. On the other hand, the term also stands for hearing protection devices and for any other devices which may improve the hearing of individuals with normal hearing, e.g. in specific acoustical situations as in a very noisy environment or in concert halls, or which may even be used in context with remote communication or with audio listening, for instance as provided by headphones. A hearing instrument for example uses a real-time live audio processor for processing a picked-up audio signal and providing the processed signal immediately to the user.

The hearing devices as addressed by the present invention are so-called active hearing devices which comprise at the input side at least one acoustical to electrical converter, such as a microphone, at the output side at least one electrical to mechanical converter, such as a loudspeaker, and which further comprise a signal processing unit for processing signals according to the output signals of the acoustical to electrical converter and for generating output signals to the electrical input of the electrical to mechanical output converter. In general, the signal processing circuit may be an analog, digital or hybrid analog-digital circuit, and may be implemented with discrete electronic components, integrated circuits, or a combination of both.

A hearing instrument thus is configured to be worn by a user and comprises an input means for picking up an audio signal, a processing unit for amplifying and/or filtering the audio signal, thereby generating a processed audio signal, and an electromechanical converter for converting the processed audio signal and outputting it to the user. These audio signals are the “ordinary” audio signals that are amplified and filtered or otherwise processed, and provided “live” to the user, that is, immediately, without being stored, according to the hearing instrument's purpose of improving the users hearing ability.

User feedback in a hearing aid currently consists of a beep or similar acoustic signal delivered to the user via the hearing aid receiver.

WO 01/30127 A2 describes a system where the audio feedback in a hearing instrument is user-definable. Different acknowledgement messages can be selected by means of exchangeable memory chips, rewriteable memory, or through communication with an external device. No specific details of storing and playback means are given.

EP 0557 847 B1 describes a mechanism for producing user feedback indentifying the program to which a hearing instrument is set. This preferably is done by representing the number of the program by a number of synthetically generated beep signals. As an alternative, “speech generation” is mentioned, but no further description of means for speech generation is given.

U.S. Pat. No. 6,839,446 B2 describes a hearing instrument in which an audio signal that has been processed by the hearing instrument can be replayed, typically in response to a user input. The sound signal is stored in an analog “bucket-brigade” circuit, or in a digital storage implementing a circular buffer.

### DESCRIPTION OF THE INVENTION

It is therefore an object of the invention to create a hearing instrument having audio feedback capability of the type mentioned initially, having improved sound generation capability.

These objects are achieved by a method for operating a hearing instrument having audio feedback capability, a hearing instrument having audio feedback capability, and a method for manufacturing a hearing instrument having audio feedback capability.

The method for operating a hearing instrument having audio feedback capability comprises the steps of
retrieving coded audio data from a storage element of the hearing instrument;
decoding the coded audio data, thereby generating a decompressed audio message signal;
optionally processing the decompressed audio message signal by the processing unit; and
outputting the decompressed and optionally processed audio message signal to the user.

By storing the message signals in coded and compressed form in a resident Memory (ROM, Flash, EEPROM, . . . ) of the hearing instrument, the message storage capability of a hearing instrument is vastly enhanced. At present and to our knowledge, there is no hearing aid system on the market that can play back audio signals or synthesize audio signals more complex than a beep. Integrating an audio decoder into a hearing aid allows playing back any audio signal stored in memory through the hearing aid. User feedback in form of Speech, Music or another type of audio signal is more helpful, pleasant and understandable to the user than a simple beep. This may be used for messages that provide feedback for the user, or may be used to play Jingles to mark a brand.

In a preferred variant of the invention, the method further comprises the steps of
inputting, to a recording device, an input audio signal;
coding the input audio signal, thereby generating a compressed audio message signal;
storing the compressed audio message signal as coded audio data in the storage element of the hearing instrument.

In a further preferred variant of the invention, the recording device is identical to the hearing instrument and the step of inputting the input audio signal is accomplished by means of a microphone of the hearing instrument. This allows the user to record individualized messages or to capture pre-recorded messages or sounds from other sources.

In a preferred variant of the invention, the method further comprises the steps of, in the course of fitting the hearing instrument to a particular user,
selecting from a plurality of available audio messages a subset of audio messages according to user preferences,
storing a plurality of units of coded audio data in the hearing instrument, each unit representing one of the subset of audio messages.

Preferably, each of the audio messages is associated with a message event or system event of the hearing instrument. The plurality of available audio messages may comprise messages in different languages, by male/female speakers etc. As a result, the hearing instrument can be configured to use a specific subset of messages, each message associated with an event. An event may also be associated with an empty message: For example, the user may choose that he or she wants to be alerted when the battery is low, but not when a program change occurs.

The term “fitting” denotes the process of determining at least one audiological parameter from at least one aural response obtained from a user of the hearing instrument, and programming or configuring the hearing instrument in accordance with or based on said audiological parameter. In this manner, parameters influencing the audio and audiological performance of the hearing instrument are adjusted and thereby tailored or fitted to the end user. For hearing instruments using software controlled analogue or digital data processing means, the fitting process determines and/or adjusts program parameters embodied in said software, be it in the form of program code instructions, algorithmic parameters or in the form of data processed by the program.

In a preferred variant of the invention, the method further comprises the step of, when coding the input audio signal, taking into account a hearing loss characteristic of a user. This adapts the information needed to represent signals according to the user's shifted perception levels in different frequency bands.

The storage requirements for the messages can thus be varied in accordance with the hearing loss. Only the information that can actually be perceived by the user is stored. The algorithms for implementing this type of compression including psychoacoustic masking etc. are known, but commonly are implemented with a standard hearing curve as a reference. In the present case, they are implemented with the actual impaired hearing curve of the respective user.

In a preferred variant of the invention, the method further comprises the step of, prior to processing the decompressed audio message signal by the processing unit, performing a compensating operation on the decompressed audio message, which compensating operation at least partially compensates for an operation performed by the subsequent processing. In another variation, the compensation operation is performed prior to compressing and storing the audio message, for a plurality of different compensation operations. Thus, the same audio message is stored in different variants, each variant corresponding to one of different operations performed by the subsequent processing, or to other characteristics of the transmission of the audio signal to the user.

This allows to compensate for the effect of different hearing instrument programs affecting the audio message signal differently and making it sound different: Different HI programs provide different transfer functions due to different acoustic input conditions. These conditions do not apply for internally generated sound. Thus the same message may sound different in different HI programs, which is undesired. The compensation operation typically is an equalisation filter, having a frequency dependent gain, in or after the audio message decoder.

The variations in subsequent processing may be caused not only by differing hearing programs being selected, but also on differing characteristics affecting the transmission path of the audio message to the user's eardrum, e.g. by differing transfer functions caused by D/A-conversion and/or varying speaker and acoustic coupling characteristics. For example, the acoustic coupling through the ear canal is estimated (given the type of hearing instrument, vent size, etc.) or measured, and the audio messages are compensated or selected accordingly.

In a preferred variant of the invention, the method further comprises the steps of
upsampling the decompressed audio message signal to have the same sampling rate as the audio signal;
merging the decompressed audio message signal with the audio signal; and
processing the merged signals by the processing unit.

This allows to reduce storage requirements for the messages. E.g. for the hearing instrument operating with a sample frequency of ca. 20 kHz of the audio signal, the audio message signal may have half the sampling frequency, i.e. ca. 10 kHz. The step of merging the signals preferably means adding or mixing the signals. Alternatively, it may mean reducing the audio signal amplitude partly or completely when a audio message signal is played.

In a preferred embodiment of the invention, the coded audio data is a transformed signal generated by an Extended Lapped Transform (ELT) of an audio message signal, in particular by a Modified Discrete Cosine Transform (MDCT) of an audio message signal, and comprising the step of computing coefficients of the transformed signal by applying said transform to the audio message signal.

A high degree of data compression is achieved by lossy compression, where information is deliberately lost to reduce the amount of data. Such lossy coders not only try to eliminate redundancy, but also irrelevance. Irrelevance is the part of the information in the signal that is (ideally) not perceptible by the human ear. In an audio coder the quantization process introduces the loss of information. Since only a finite number of bits are available to represent a number with (theoretically) infinite precision, the number is rounded to the nearest quantization level. The error between the quantized value and the actual value is called the quantization error or noise and can be assumed to be a white noise process. Perceptual audio coders such as MP3 attempt to hide the quantization noise under the human perception threshold. This way, even the fairly high quantization noise generated by large data reduction remains imperceptible by the human ear (irrelevance). A preferred solution presented here does not include such a perceptual shaping of the quantization noise. Instead, it attempts to minimize the overall quantization noise in a mathematical sense. This is not as efficient as a perceptual scheme but is computationally less expensive.

Alternatively, other audio coders with increased coding efficiency may be used, e.g.:
Adaptive Quantization: In Adaptive Quantization the number of bits used to encode a coefficient is variable and are calculated on-line according to the changing statistics of the signal.
Perceptual Coding: Most modern audio coders exploit the properties of the human hearing to eliminate any redundant information in the signal. The idea is to reduce the quantization of the signal in places were the resulting error will not be heard by the human ear. This is costly to implement but will significantly improve the performance of the coder. A psychoacoustical model for coding may also include the hearing loss of the listener to further increase performance.
A different type of coder also considered is the ADPCM coder. This algorithm is based on predictive filtering of individual subbands of a signal obtained by a filterbank. A predictive filter effectively reduces the redundancy in a signal and allows more efficient quantization. The big advantage of this scheme however is the low encoding-decoding delay.
Entropy coding is a technique used in most communication systems where the statistics of a signal are used to determine the optimal assignment of symbols to values. For example, if there are 4 possible symbols that are being transmitted, and the first is the one occurring most frequently, the shortest codeword will be used to represent this symbol, thus reducing the average data rate.
Vector quantization: This type of quantization takes an input vector and compares it to a predefined number of vectors (code vectors). The code vector which represents the input vector the best in a certain sense (minimum square error for example) is used. Every code vector has an index that is then transmitted.

In a preferred variant of the invention, the method further comprises the step of, when decoding the coded audio data, extracting side information from the coded audio data, which side information represents normalization factors for the coefficients of the transformed signals. Normalizing the coefficients increases the coding accuracy and/or efficiency when coding the coefficients, but requires that the normalization coefficients be transmitted along with the transform coefficients.

In a preferred variant of the invention, the method further comprises the step of, when decoding the coded audio data, decoding the side information by means of a predictor-based coding scheme. This implies that the side information was encoded by a predictor based encoder. Coding the side information in this manner further reduces the number of bits to be stored.

In a preferred variant of the invention, the method further comprises the step of determining the decoded normalization factors by taking the inverse logarithm of the decoded side information. This implies that not the normalization coefficients themselves were encoded as the side information, but rather a logarithm of the normalization coefficients. It appears that this improves the coding efficiency even more.

In a preferred variant of the invention, the method further comprises the steps of
a first processor retrieving coded audio data from the storage element;
the first processor alternately writing blocks of coded audio data to a first and a second buffer;
a second processor alternately reading the blocks of coded audio data from the first and second buffer;
controlling the second processor to read from the first buffer during periods of time in which the first processor is allowed to write to the second buffer, and controlling the second processor to read from the second buffer during periods of time in which the first processor is allowed to write to the first buffer.

This use of a double buffer allows to synchronise the operation of the first processor—typically the main microprocessor or controller of the hearing instrument—with the operation of the second processor—typically a digital signal processor (DSP) that does the actual signal processing.

In a preferred variant of the invention, the method further comprises the steps of
when a message event occurs, outputting an audio message signal associated with said message event;
when a further message event occurs, stopping the outputting of the audio message signal; and, optionally,
outputting a further audio message signal associated with said further message event.

The playback of an audio message takes some time. In some circumstances it might be necessary to play a new message instantaneously, without waiting for the current message to finish. Therefore, the audio playback mechanism is interruptible. For example, the user wants to toggle through the whole sequence of programs. He presses the toggle button repeatedly. The audio messages corresponding to intermediate steps are interrupted and only the last one is played in full length.

In a preferred variant of the invention, the method further comprises the step of, prior to outputting an audio message signal, outputting an alert signal for indicating the beginning of an audio message signal. This allows to precede each voice message by an intro sound, and has the following advantages for the user:
The user pays attention to the message and understands the information. There is no need to repeat the message.
The user can identify the message as being information from the HI and not as someone else speaking.

The intro sound can be a simple beep or a jingle or a sequence thereof. The intro sound can be the same for all messages or it can be different for different categories of messages. Furthermore, the same or a different sound may be played to show the end of a message.

In a preferred variant of the invention, the method further comprises the step of generating a combined audio message signal by concatenating a sequence of separately coded and stored audio message signals. This allows to assemble a message from a sequence of elementary “building blocks”, which may be e.g. phrases, words, syllables, triphones, biphones, phonemes. The building blocks are stored, and for each message, the list of building blocks making up the message is stored.

In yet a further preferred embodiment of the invention, the intonation and stress or, in general, prosody parameters of the audio message are modulated. This modulation may take place when recording the message, fitting the hearing instrument, and/or when reconstructing and playing back the audio message. This allows adapting the intonation of a message to a situation of the user or to the status of the hearing instrument. Voice Messages may be modulated either by applying filtering techniques to pre-recorded samples or storing different instances of the same sentence, but spoken differently. Different Messages are preferably given different intonation to enhance the intended meaning. For example, a message alerting the user of low battery may be increasingly stressed if the user ignores it. The speech messages may be adapted to the user's mood. The mood may for example be detected by the frequency of the user switching the controls: Switching the UI controls often in the last few minutes may be interpreted to indicate that the user is irritated. Accordingly, speech messages may be made to sound more soothing. Speech Messages may also be adapted to the current acoustical situation, e.g. quiet or loud surroundings, enhancing certain frequency bands in loud surroundings. The principles for adapting prosody parameters are known in the literature.

Furthermore, the audio signals may be spatialized using binaural filtering or standard multichannel techniques. Different messages could be located at different positions, depending on the meaning, or which hearing aid it is coming from. A binaurally spatialized message may be more comfortable and natural to the listener.

In a preferred embodiment of the invention, the decompressed audio signal is output to the user by means of the electromechanical converter of the hearing instrument. In another preferred embodiment of the invention, the decompressed audio signal is output to the user by means of a converter of a further device, the further device being separate from the hearing instrument, and the method comprising the step of transmitting the decompressed audio signal from the hearing instrument to the further device

The hearing instrument having audio feedback capability comprises
a storage element for storing coded audio data;
a decoder for decoding coded audio data retrieved from the storage element and for thereby generating a decompressed audio message signal;
a signal merger for inserting the decompressed audio message signal into the signal path of the audio signal.

The point of merging, e.g. creating a weighted sum of the audio signal and the audio messages signal may lie before, in or after the main processing of the audio signal.

In a preferred embodiment of the invention, the hearing instrument comprises a coder for coding an input audio signal picked up by the input means, thereby generating a compressed audio message signal, and for storing the compressed audio message signal as coded audio data in the storage element.

In a preferred embodiment of the invention, the hearing instrument comprises data processing means configured to perform the method steps described above. In a preferred embodiment of the invention, the data processing means is programmable.

The method for manufacturing a hearing instrument having audio feedback capability comprises first the steps of assembling into a compact unit, an input means for picking up an audio signal, a processing unit for amplifying and/or filtering the audio signal, thereby generating a processed audio signal, and an electromechanical converter for converting the processed audio signal and outputting it to the user. The method then comprises the further steps of providing, as elements of the hearing instrument,
a storage element for storing coded audio data;
a decoder for decoding coded audio data retrieved from the storage element and for thereby generating a decompressed audio message signal;
a signal merger for inserting the decompressed audio message signal into the signal path of the audio signal.

Further preferred embodiments are evident from the dependent patent claims. Features of the method claims may be combined with features of the device claims and vice versa, and the features of the preferred variants and embodiments may be combined freely with one another.

### BRIEF DESCRIPTION OF THE DRAWINGS

The subject matter of the invention will be explained in more detail in the following text with reference to preferred exemplary embodiments, which are illustrated in the attached drawings, in which is schematically shown, in:

FIG. 1 a structure of a hearing instrument;

FIG. 2 a block diagram for decoding an audio message signal;

FIG. 3 a block diagram for coding an audio message signal;

FIG. 4 a format of coded audio data;

FIG. 5 a communication flow when retrieving coded audio data;

FIG. 6 a predictor-based coder;

FIG. 7 a predictor-based decoder; and

FIG. 8 a block diagram illustrating a further inventive aspect.

The reference symbols used in the drawings, and their meanings, are listed in summary form in the list of reference symbols. In principle, identical parts are provided with the same reference symbols in the figures.

### DETAILED DESCRIPTION OF PREFERRED EMBODIMENTS

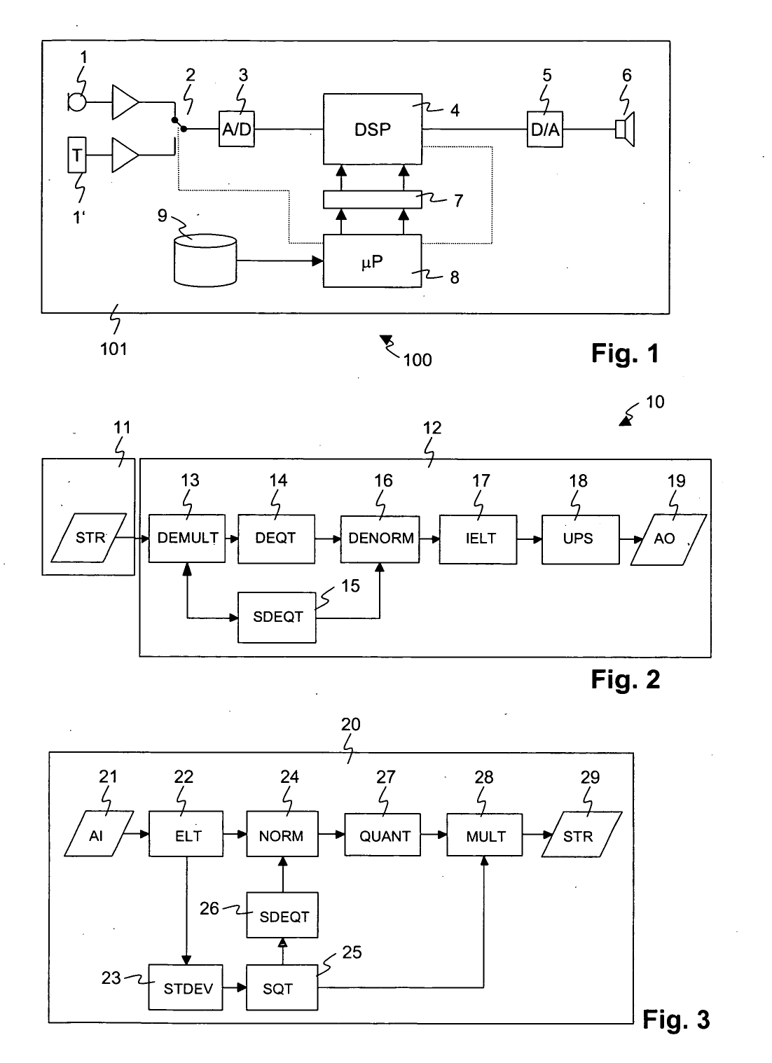

FIG. 1 schematically shows a structure of a hearing instrument 100. The elements of the hearing instrument 100 are arranged in a housing 101. The housing 101 is shaped to be arranged behind or inside a user's ear. The hearing instrument 100 comprises input means such as a microphone 1 or a telephone coil 1′ or a wireless receiver (not shown). Signals from the input means 1, 1′ are pre-amplified in analog form and selected by a selector switch 2, converted to a digital representation by an analog to digital converter 3, and processed by a digital signal processor (DSP) 4. In another embodiment of the invention, signals from different input means 1, 1′ are both amplified, combined, and provided to the DSP, or combined by the DSP. The DSP 4, the selector 2 and further elements of the hearing instrument 100 are controlled (dotted lines) by a microprocessor 8. The microprocessor 8 is arranged to retrieve coded audio data from a data store 9 and to forward them to the DSP 4 by means of a double buffer 7. User input may be provided to the microprocessor 8 by means of user controls 102 such as switches or toggle switches, or by wireless remote control (not shown). The processed audio signal generated by the DSP DSP 4 is passed to a digital to analog converter 5, amplified and output to the user by means of a speaker 6. This outputting may alternatively also be implemented in a separate device.

FIG. 2 schematically shows a block diagram 10 for decoding an audio message signal. The functionality represented by this block diagram 10 is implemented by the elements of the hearing instrument 100. In retrieval block 11, coded audio data is retrieved from the data store 9 and provided as a stream of data blocks (STR) to a processing unit such as the DSP 4 embodying a decoding block or function 12. The decoding function 12 is e.g. realized in a dedicated time slot of the DSP's task allocation schedule. First, the data stream, in demultiplexer block 13 (DEMULT), is separated into data and side information. Next, in dequantization block 14 (DEQT), the coded data is decoded, generating decoded data. The decoding step typically involves a look-up table associating codewords with output values and implicitly realizes a nonlinear scaling of the signal. In parallel, in side info dequantization block 15 (SDEQT), the side information is decoded.

In a preferred embodiment of the invention, the side info dequantization block 15 also performs a decoding of the side information, e.g. by means of a predictive decoder, as explained later on.

In denormalization block 16 (DENORM), the decoded data is denormalized in accordance with the side information, resulting in transform coefficients representing the audio message signal. In inverse transform block 17 (IELT), the time sequence of audio data points is recreated from the transform coefficients. This preferably is done by means of the inverse of the Extended Lapping Transform (ELT) explained in detail further below. In optional upsampling block 18 (UPS), the audio signal is upsampled, and in output block 19 (AO) the upsampled audio signal is provided for further processing, typically to the DA converter 5 of the hearing instrument 100 or the external device.

FIG. 3 schematically shows a block diagram 20 for coding an audio message signal. The functionality represented by this block diagram 10 is implemented by the elements of the hearing instrument 100, or by a separate data processing unit such as a personal computer, audiology workstation etc. Audio input block 21 (AI) provides for a time sequence of digital samples representing an audio signal from a microphone or from a recording. Windowing block 22 (ELT) separates this data stream into a sequence of overlapping window blocks, and performs the ELT explained below. The transform coefficients are provided both to standard deviation calculation block 23 (STDEV) and normalization block 24 (NORM). The standard deviation calculation block 23 computes, for each transform coefficient, its standard deviation over a set of most recent values, e.g. over the last 8 values. These standard deviation values constitute the side information. The actual values of the transform coefficients are scaled, in normalization block 24, in accordance with this standard deviation. The scaling is done with the standard deviation values obtained by first quantizing the side information in side info quantization block 25 (SQT) and the dequantizing it again in side info dequantization block 26 (SDEQT). This ensures that the standard deviation values used in normalization block 24 are exactly the same as those used in denormalization block 16 when decoding.

In a preferred embodiment of the invention, the side info quantization block 25 also performs a coding of the side information, e.g. by means of a predictive encoder, as explained later on.

In quantization block 27 (QUANT), the normalized coefficients are quantized. This quantization step ultimately causes the data compression. In multiplexing block 28 (MULT), the quantized coefficients are interleaved with the side info, generating a data stream (STR) output in block 29 to a storage or a transmission channel.

In FIGS. 2 and 3, the main functional block of the system is the ELT which implements the time-frequency transform. The purpose of the transform is to decorrelate the samples in the signal. The decorrelated samples will have a lower variance than the original samples and can therefore be encoded with less bits for the same signal to noise ratio (SNR). This reduction is called the coding gain and will be discussed in more detail further below. The coder described here uses principles taken from Audio Coding schemes often referred to as Transform Coders. These include the popular MP3, AAC or ATRAC Audio Coders. Unlike advanced coding schemes mentioned, the ELT as presented here does not use perceptual models for quantization noise masking, as these are costly to implement on hardware currently available.

In a preferred embodiment of the invention, the audio message coder and encoder run on a sampling frequency of 10 kHz. The output is then upsampled to the sample frequency of 20 kHz as used in the remaining hearing instrument 100.

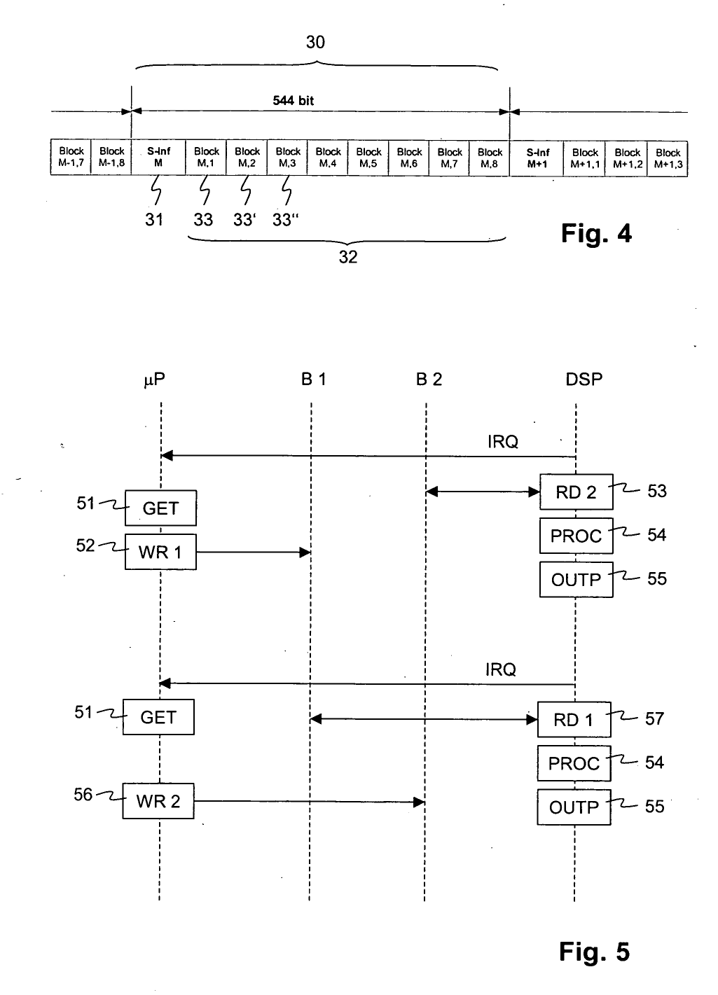

FIG. 4 schematically shows a format of the coded audio data generated by multiplexer 28 and disassembled by demultiplexer 13. A stored or transmitted data stream consists of a sequence of frames 30, each frame comprising one block of side info 31 and a sequence 32 of e.g. eight data blocks 33, 33′, 33″. In a preferred embodiment of the invention, the length of the side information is 32*3 Bit=96 Bit, and the length of the Data blocks is variable; e.g. 8*48 Bit=384 Bit, 8*56 Bit=448 Bit or 8*64=512 Bit.

The coded data is stored in a non-volatile memory data store 9 of the hearing instrument 100 and transferred to the DSP 4 by the microprocessor 8 or controller. For the case in which the DSP 4 and the microprocessor 8 are not synchronized, a suitable mechanism for passing the data to the DSP 4 is required. As mentioned in the context of FIG. 1, this data passing is achieved by means of a double buffer 7.

FIG. 5 schematically shows a communication flow when retrieving coded audio data and passing it to the DSP 4 through the double buffer 7. Since there is no common clock, operations are synchronized by the DSP 4 sending an interrupt request IRQ to the microprocessor 8, denoted as μP. The routine associated with the interrupt request IRQ has sufficient priority to fetch the next block of coded data (step 51, GET) and write it (step 52, WR 1) to a first buffer B1 of the double buffer 7 in the course of a common cycle time of e.g. 25 ms. During this time, the DSP 4 reads the coded data previously stored in the second buffer B2 (step 53, RD 2), decodes it (step 54, PROC), merges it with the ordinary audio signal and passes the merged signal to the DA converter 5 (step 55, OUTP). Then the DSP 4 issues a further IRQ, causing the microprocessor 8 to fetch the next block of coded data and write it to the second buffer B2 (step 56, WR 2), while the DSP 4 reads from the first buffer B1 (step 57, RD 1).

This double buffering mechanism is implemented in separate threads or time frames, once for retrieving the data blocks 32, 32″, 32″ and once (used less often) for retrieving the side info blocks 31.

The Extended Lapping Transform (ELT) as mentioned previously serves to reduce the correlation between samples. The basic principles are commonly known, the following is a summary of the forward transform. The inverse transform is analogous to the forward transform.

The ELT decomposes the signal into a set of basis functions. The resulting transform coefficients have a lower variance than the original samples. The coding gain is defined as:

$${G}_{c} = \frac{{σ}_{f}^{2}}{{σ}_{t}^{2}} \qquad ( 1 )$$

Where σ_{ƒ}² is the variance of the transform coefficients and σₜ ² the variance of the time-domain samples. To describe the ELT, we start by defining a type 4 Discrete Cosine Transform (DCT):

$${f}_{k} = {\sum }_{i = 0}^{n - 1} {x}_{k} cos [ \frac{π}{n} ( k + \frac{1}{2} ) ( i + \frac{1}{2} ) ] \qquad ( 2 )$$

Where n is the block length and i is the coefficient index. The DCT can be applied blockwise to a signal with a rectangular window and reconstruction can be achieved by the inverse transform. The rectangular window however introduces blocking artefacts which are audible in the reconstructed signal. By using an overlapping window these artefacts can be reduced and the coding gain increased. The ELT is therefore usually used in signal compression applications. This transform can be implemented through the DCT and uses an overlapping transform window while maintaining critical sampling. Increasing the transform length with an overlapping window would normally result in an oversampling of the signal which is clearly undesirable in data compression. The ELT can be defined for window lengths that are integer multiples of N=2Kn, where n is the length of the corresponding DCT, K is an integer and N is the ELT length. For an overlapping factor K=2:

$${f}_{k} = {\sum }_{i = 0}^{N - 1} {\tilde{x}}_{i} cos [ \frac{π}{N} ( k + \frac{1}{2} ) ( i + \frac{1}{2} + \frac{N}{2} ) ] \qquad ( 3 )$$

The ELT with K=2 is applied to blocks of consecutive data where the window has a 75% overlap and is four times as long as the transform. Consequently, this ELT is a transform that has ¼ as many outputs as inputs. The performance of the transform can be further increased by using a window that tapers to zero towards the edges. To achieve perfect reconstruction, the power of the reconstructed signal must be the same as the original signal. This places some constraints on the window shape. It has to be symmetric, i.e. wᵢ=w_{2Kn-1-i}, and it must fulfil the property in equation 4.
wᵢ²+w_{i+Kn}²=1 (4)
The square of adjacent windows must add up to 1. There are many windows that satisfy this requirement. In this work, the window in equation 5 is used.

$${w}_{i} = - \frac{1}{2 \sqrt{2}} + \frac{1}{2} cos ( ( i + \frac{1}{2} ) \frac{π}{M} ) \qquad ( 5 )$$

with i=0 . . . 127. For an even length n the above formula can be implemented using a DCT type 4 and some “folding” of the windowed block of length 2n=N, exploiting symmetries of the basic equations. This can be expressed as a set of Butterfly equations (in slightly different notation, the coefficients ƒₖ being denoted as u(i) and the ELT length N being denoted as M):

$$\begin{matrix}u ( i ) = {s}_{0} ( {x}_{m} ( \frac{M}{2} + i ) {s}_{1} ( i ) - {x}_{m} ( \frac{M}{2} - 1 - i ) {c}_{1} ( i ) ) + {c}_{0} {z}^{- 2} ( {x}_{m} ( \frac{M}{2} - 1 - i ) {s}_{1} ( i ) + {x}_{m} ( \frac{M}{2} + i ) {c}_{1} ( i ) ) & ( 6 ) \\ u ( M - 1 - i ) = {z}^{- 1} ( {s}_{0} {z}^{- 2} ( {x}_{m} ( \frac{M}{2} - 1 - i ) {s}_{1} ( i ) + {x}_{m} ( \frac{M}{2} + i ) {c}_{1} ( i ) ) - {c}_{0} ( {x}_{m} ( \frac{M}{2} + i ) {s}_{1} ( i ) - {x}_{m} ( \frac{M}{2} - 1 - i ) {c}_{1} ( i ) ) ) & ( 7 )\end{matrix}$$

Where i=0,1, . . . , M/2−1 and the c₀,s₀,c₁,s₁ represent the window and are defined as:
c₀=cos(θ₀)
c₁=cos(θ₁)
s₀=sin(θ₀)
s₁=sin(θ₁) (8)
Where

$$\begin{matrix}{θ}_{0} = - \frac{π}{2} + {μ}_{n + \frac{M}{2}} \\ {θ}_{1} = - \frac{π}{2} + {μ}_{\frac{M}{2} - 1 - n} & ( 9 ) \\ {μ}_{k} = ( ( \frac{1 - γ}{2 M} ) ( 2 k + 1 ) + γ ) \frac{( 2 k + 1 ) π}{8 M} & ( 10 )\end{matrix}$$

The parameter Γ is between 0 and 1 and is set to 0.5 in this case. In a preferred embodiment of the invention, the length n of the transform is 32 to allow the use of a particular FFT Coprocessor to calculate the transform. Correspondingly, in a preferred embodiment of the invention, N is 128 and so is M.

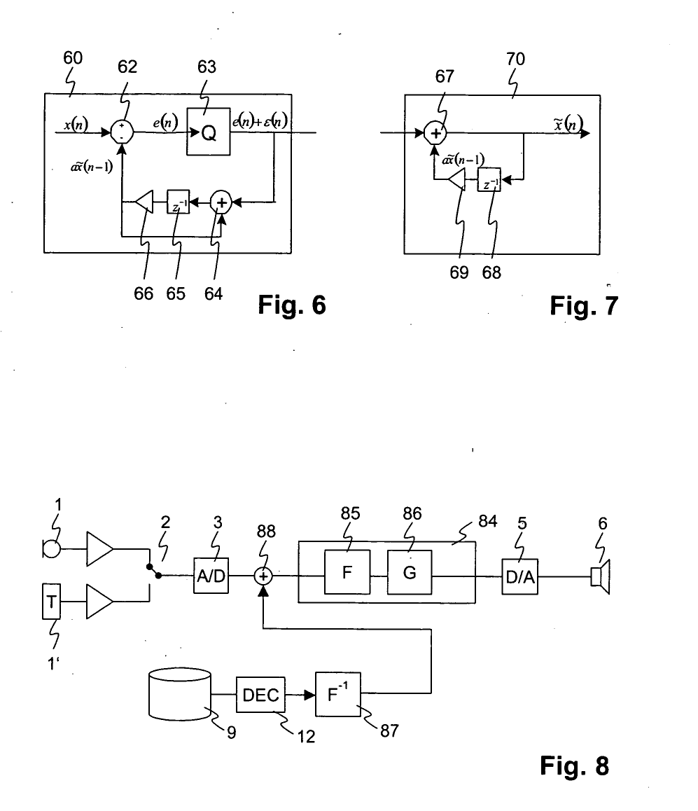

FIG. 6 schematically shows a predictor-based coder implemented as part of the side info quantization block 25. In order to quantize the Side Information more efficiently, the logarithm base 2⁶⁴ of the standard deviation is taken and a prediction algorithm is applied. Like the time-frequency transform, the predictor decorrelates samples in a sequence, thereby reducing the variance. The scheme used here is a simple first-order closed-loop predictor comprising an adder 64, a time delay 65 and a gain 66 corresponding to the prediction coefficient. Its output is subtracted from the input signal x(n) by a difference operator 62 and the difference is quantized by quantizer 63. The output of the quantizer 63 is input to the adder 64 of the predictor. Equation 11 shows the optimal result of the prediction algorithm.
σ_{y}²=(1−α²)σₓ² (11)

Where σ_{y}² is the variance of the output, σₓ² the variance of the input and α the prediction coefficient, in this case 0.98.

FIG. 7 schematically shows the corresponding predictor-based decoder implemented as part of the dequantization block 15. It comprises the inverse predictor with adder 67, delay 68 and gain 69, which is the same as in the encoder. The prediction is performed with the signal after it has been quantized and dequantized again. This ensures that the value at the output of the inverse quantizer is the same in encoder and decoder, as is shown in equation 12.
e(n)=x(n)−a\tilde{x}(n−1)
\tilde{x}(n)=e(n)+a\tilde{x}(n−1)+ε(n)=x(n)+ε(n) (12)

The values \tilde{x}(n) at the output of the predictor have a probability density function that approaches a Gaussian distribution, i.e. they approach a white noise sequence. The side information can therefore be quantized with Gaussian quantizers. The combination of log function and prediction allows the side information to be transmitted with 3 bits only, leaving more bandwidth for the Data.

FIG. 8 schematically shows a block diagram conceptually illustrating, in terms of signal flow, the compensation of at least part of the subsequent processing. The ordinary audio signal flow path passes from input device 1, 1′ over selector 2 and A/D-Converter 3 into the main processing block 84. The processed signal to be output is fed from the main processing block 84 to the D/A-Converter 5, an amplifier and to the speaker 6. The main processing block may be regarded as comprising a first processing operation 85 and a second processing operation 86 (where “first” and “second” do not necessarily imply a particular sequence of these operations). The first processing operation 85 (F) typically is a generic processing operation corresponding to the hearing program chosen. The second processing operation 86 (G) typically is a user specific adaptation and usually is much more complex than the first processing operation.

In a preferred embodiment of the invention, the audio message signal retrieved from the store 9, after decoding in decoding block 12, is passed through an inverse function block 87 and added to the main signal flow path by adder 88 before the main processing block 84. The inverse function block 87 implements at least approximately the inverse (F⁻¹) of the first processing operation 85 (F) in order to reduce or minimize the effect of the first processing operation 85 on the audio message signal. The function of the inverse function block 87 is changed in accordance with the hearing program functions embodied in the first processing operation 85. Typically, the inverse function block 87 is in reality implemented on the DSP 4 under control of the microprocessor 8 as are the other processing functions.

While the invention has been described in present preferred embodiments of the invention, it is distinctly understood that the invention is not limited thereto, but may be otherwise variously embodied and practised within the scope of the claims.

1. A method for operating a hearing instrument having audio feedback capability, the hearing instrument being configured to be worn by a user and comprising an input means for picking up an audio signal, a processing unit for amplifying and/or filtering the audio signal, thereby generating a processed audio signal, and an electromechanical converter for converting the processed audio signal and outputting it to the user,
wherein the method comprises the steps of
retrieving coded audio data from a storage element of the hearing instrument;
decoding the coded audio data, thereby generating a decompressed audio message signal;
optionally processing the decompressed audio message signal by the processing unit; and
outputting the decompressed and optionally processed audio message signal to the user.

2. The method of claim 1, further comprising the steps of
inputting, to a recording device, an input audio signal;
coding the input audio signal, thereby generating a compressed audio message signal;
storing the compressed audio message signal as coded audio data in the storage element of the hearing instrument.

3. The method of claim 2, wherein the recording device is identical to the hearing instrument and the step of inputting the input audio signal is accomplished by means of a microphone of the hearing instrument.

4. The method of claim 1 or claim 2, comprising the steps of, in the course of fitting the hearing instrument to a particular user,
selecting from a plurality of available audio messages a subset of audio messages according to user preferences, and optionally selecting and/or modifying audio messages according to settings of the hearing instrument and/or according to transmission characteristics affecting the audio message on its way to the user's eardrum; and
storing a plurality of units of coded audio data in the hearing instrument, each unit representing one of the subset of audio messages.

5. The method of claim 2 or 3, comprising the step of
when coding the input audio signal, taking into account a hearing loss characteristic of a user, adapting the information needed to represent signals according to the user's shifted perception levels in different frequency bands.

6. The method of claim 3, comprising the step of
prior to processing the decompressed audio message signal by the processing unit, performing a compensating operation on the decompressed audio message, which compensating operation at least partially compensates for an operation performed by the subsequent processing.

7. The method of claim 1, comprising the steps of
upsampling the decompressed audio message signal to have the same sampling rate as the audio signal;
merging the decompressed audio message signal with the audio signal; and
processing the merged signals by the processing unit.

8. The method of claim 1, wherein the coded audio data is a transformed signal generated by an Extended Lapping Transform (ELT) of an audio message signal, in particular by a Discrete Cosine Transform (DCT) of an audio message signal, and comprising the step of
computing coefficients of the transformed signal by applying said transform to the audio message signal.

9. The method of claim 8, comprising the step of
when decoding the coded audio data, extracting side information from the coded audio data, which side information represents normalization factors for the coefficients of the transformed signals.

10. The method of claim 9, comprising the step of
when decoding the coded audio data, decoding the side information by means of a predictor-based coding scheme.

11. The method of claim 9 or 10, comprising the step of
determining the decoded normalization factors by taking the inverse logarithm of the decoded side information.

12. The method of claim 1, comprising the steps of
a first processor retrieving coded audio data from the storage element;
the first processor alternately writing blocks of coded audio data to a first and a second buffer;
a second processor alternately reading the blocks of coded audio data from the first and second buffer;
controlling the second processor to read from the first buffer during periods of time in which the first processor is allowed to write to the second buffer, and controlling the second processor to read from the second buffer during periods of time in which the first processor is allowed to write to the first buffer.

13. The method of claim 1, comprising the steps of
when a message event occurs, outputting an audio message signal associated with said message event;
when a further message event occurs, stopping the outputting of the audio message signal; and, optionally,
outputting a further audio message signal associated with said further message event.

14. The method of claim 1, comprising the step of
prior to outputting an audio message signal, outputting an alert signal for indicating the beginning of an audio message signal.

15. The method of claim 1, comprising the step of
generating a combined audio message signal by concatenating a sequence of separately coded and stored audio message signals.

16. The method of claim 1, comprising the step of
modulating the intonation and stress or, in general, prosody parameters of the audio message.

17. The method of claim 1, wherein the decompressed audio signal is output to the user by means of the electromechanical converter of the hearing instrument.

18. The method of claim 1, wherein the decompressed audio signal is output to the user by means of a converter of a further device, the further device being separate from the hearing instrument, and the method comprising the step of transmitting the decompressed audio signal from the hearing instrument to the further device.

19. A hearing instrument having audio feedback capability configured to be worn by a user and comprising an input means for picking up an audio signal, a processing unit for amplifying and/or filtering the audio signal, thereby generating a processed audio signal, and an electromechanical converter for converting the processed audio signal and outputting it to the user, wherein the hearing instrument comprises
a storage element for storing coded audio data;
a decoder for decoding coded audio data retrieved from the storage element and for thereby generating a decompressed audio message signal;
a signal merger for inserting the decompressed audio message signal into the signal path of the audio signal.

20. The hearing instrument of claim 19, comprising a coder for coding an input audio signal picked up by the input means, thereby generating a compressed audio message signal, and for storing the compressed audio message signal as coded audio data in the storage element.

21. The hearing instrument of claim 19, comprising data processing means configured to perform the method steps of one of claims 4 to 16.

22. A method for manufacturing a hearing instrument having audio feedback capability configured to be worn by a user, comprising the steps of assembling into a compact unit, an input means for picking up an audio signal, a processing unit for amplifying and/or filtering the audio signal, thereby generating a processed audio signal, and an electromechanical converter for converting the processed audio signal and outputting it to the user, comprising the further steps of providing, as elements of the hearing instrument, and assembling into the hearing instrument unit:
a storage element for storing coded audio data;
a decoder for decoding coded audio data retrieved from the storage element and for thereby generating a decompressed audio message signal;
a signal merger for inserting the decompressed audio message signal into the signal path of the audio signal.
